(19) United States
(12) Patent Application Publication
(10) Pub. No.: US 2012/0301753 A1
(43) Pub. Date: Nov. 29, 2012

(54) ELECTROLYTE STORAGE STRUCTURE FOR A LITHIUM BATTERY

(75) Inventors: Chin-Ming Chen, Gueishan Township (TW); Te-Chuan Lai, Gueishan Township (TW); Jing-Yih Cherng, Gueishan Township (TW)

(73) Assignee: AMITA TECHNOLOGIES INC LTD.

(21) Appl. No.: 13/246,836

(22) Filed: Sep. 27, 2011

(30) Foreign Application Priority Data
May 23, 2011 (TW) 100209217

(51) Int. Cl. H01M 10/42

(52) U.S. Cl. 429/48

(57) ABSTRACT

An electrolyte storage structure for a lithium battery made of a battery core having a stack with positive electrode plates, negative electrode plates and separating films, a battery core positive electrode welded with the positive electrode plate, a battery core negative electrode welded with the negative electrode plate, electrolyte, and a cup for receiving the battery core, positive electrode plate, the negative electrode plate and the electrolyte. The cup has a receiving space for accommodating the electrolyte core, the positive electrode plate and the negative electrode plate, and the electrolyte is disposed separately from the battery core. The electrolyte is released and flows into the receiving space for infiltrating the battery core before the battery is set to use. The battery core is infiltrated and saturated with the electrolyte. Then the saturated lithium battery undergoes following procedures of charging and activation to generate a finished lithium battery.

### BACKGROUND OF THE INVENTION

1. Field of the Invention

The present invention relates to a lithium battery, in particular, relates to a structure relating with manufacturing processes for adding electrolyte used in a lithium battery.

2. Description of Prior Art

The development of the electronic industry is prosperous. Various electronic devices become popular. In the development of portable electronic devices, it is critical to minimize the dimension and reduce weight of a device. With the advancement of the technology, a portable electronic device is capable of delivering more and more the functions and the power consumption increases. As a result, battery life gradually becomes a critical factor in product development and manufacturing of electronic devices.

The majority of portable electronic devices in the market place use lithium secondary batteries which are rechargeable and have large dimensions and mass energy densities. A lithium battery is made of a battery core which is a stack of a plurality of positive electrode plates, negative electrode plates and separating film. A cup made of laminated aluminum films is used for packaging the battery core, positive electrode plates, negative electrode plates, and non-aqueous electrolyte (referred as electrolyte). A semi-finished battery undergoes procedures of charging, activation tests, degassing and voltage tests to generate a finished lithium battery. However, charged lithium batteries are considered as hazardous articles when shipping to sales locations and generate high shipping cost.

Accordingly, it is desirable to provide an innovative lithium battery structure, which is made as an uncharged semi-finished lithium battery. The semi-finished lithium battery undergoes simple procedures to infiltrate a battery core with electrolyte, charging, activation etc. to rapidly generate a finished lithium battery at ease.

### SUMMARY OF THE INVENTION

The primary objective of the present invention is to provide an electrolyte storage structure for a lithium battery. The electrolyte and the battery core in a lithium battery are disposed separately to make a semi-finished lithium battery. The semi-finished lithium battery is free from damaging, deterioration, and accidents such as explosions during shipment. When it is required to make finished lithium batteries, the semi-finished lithium batteries undergo following procedures of releasing electrolyte to infiltrate battery cores, charging, activation etc.

In order to accomplished the above goal, the present invention has a battery core having a stack with positive electrode plates, negative electrode plates and separating films, a battery core positive electrode welded with the positive electrode plate, a battery core negative electrode welded with the negative electrode plate, electrolyte, and a cup for receiving the above mentioned battery core, the positive electrode plates, the negative electrode plate and the electrolyte. The cup has a receiving space for accommodating the electrolyte core, the positive electrode plate and the negative electrode plate, and the electrolyte is disposed separately from the battery core. The semi-finished battery is safe and stable to storage in a warehouse and in shipment. The electrolyte is released and flows into the receiving space for infiltrating the battery core before the battery is set to use. The battery core is infiltrated and saturated with the electrolyte. Then the saturated lithium battery undergoes following procedures of charging and activation to generate a finished lithium battery.

Compare to prior art, an advantage of the present invention is that the electrolyte and battery core in a lithium battery are disposed separately to generate a semi-finished lithium battery. In the semi-finished lithium battery, the electrolyte is not in contact with the battery core, and the semi-finished lithium battery is not charged, which made the semi-finished lithium battery is suited for warehousing and shipment. In addition, the semi-finished lithium battery is not damaged after kept in a warehouse for a long time and is free from the risks such as explosion during shipment. Further, when it is required to generate a finished lithium battery, a semi-finished lithium battery undergoes simple manufacturing process of releasing the electrolyte in semi-finished lithium battery to infiltrate the battery core with electrolyte, performing charging, activation and testing to generate a finished lithium battery at ease.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an exploded diagram of a preferred embodiment according to the present invention;

FIG. 2 is a structural sectional diagram of a preferred embodiment according to the present invention;

FIG. 3A is a schematic diagram of the electrolyte bag of a preferred embodiment according to the present invention;

FIG. 3B is a schematic diagram of the electrolyte bag of the other preferred embodiment according to the present invention;

FIG. 4A is a schematic diagram of the electrolyte release of the first preferred embodiment according to the present invention;

FIG. 4B is a schematic diagram of the electrolyte release of the second preferred embodiment according to the present invention;

FIG. 5 is an expanded diagram of the cup of a preferred embodiment according to the present invention;

FIG. 6A is a structural sectional diagram of another preferred embodiment according to the present invention;

FIG. 6B is a structural sectional diagram of the other a preferred embodiment according to the present invention;

FIG. 7A is a schematic diagram of the electrolyte release of the third preferred embodiment according to the present invention; and

FIG. 7B is a schematic diagram of the electrolyte release of the fourth preferred embodiment according to the present invention.

### DETAILED DESCRIPTION OF THE INVENTION

In cooperation with attached drawings, the technical contents and detailed description of the present invention are described thereinafter according to preferred embodiments, being not used to limit its executing scope. Any equivalent variation and modification made according to appended claims is all covered by the claims claimed by the present invention.

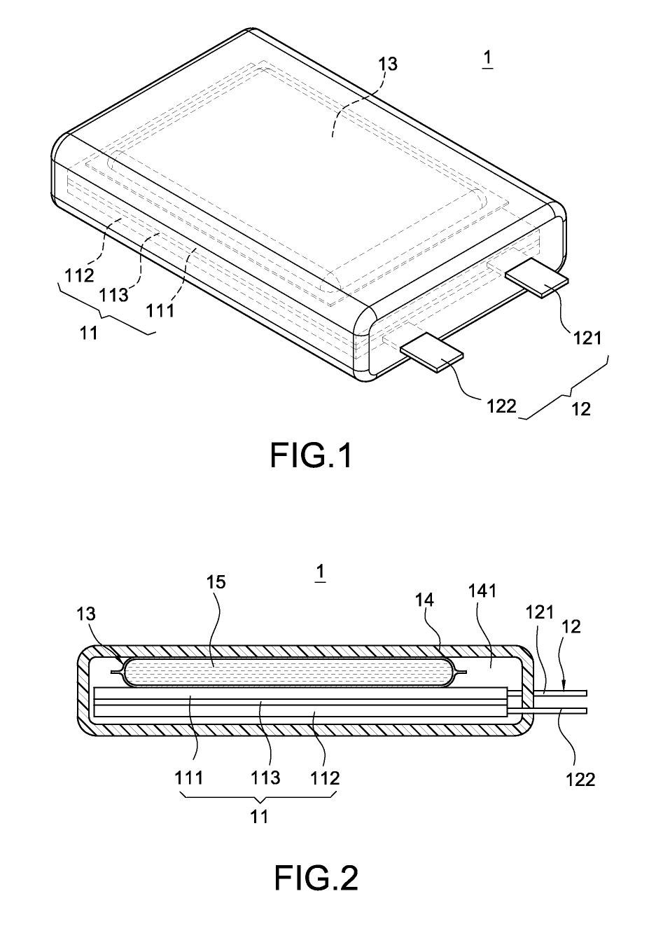

FIG. 1 and FIG. 2 are is an exploded diagram and a structural sectional diagram of a preferred embodiment according to the present invention. As shown in the diagrams, the lithium battery 1 has a battery core 11, two electrode plates 12 and a cup 14 according to the present invention. The battery core 11 is a stack having positive electrode plates 111 and negative electrode plates 112 arranged in order. A separating film 113 is provided between the positive electrode plates 111 and the negative electrode plates 112 for preventing the positive electrode plates 111 contacting the negative electrode plates 112.

In the embodiment, the lithium battery 1 also includes an electrolyte bag 13 in a form of a sealed bag. The electrolyte bag 13 is made of corrosion resistant materials. Specifically, the electrolyte bag 13 is made of Polypropylene (PP) or Polyethylene (PE) but is not limited thereto. The electrolyte 15 is accommodated in the electrolyte bag 13 in the lithium battery 1 and disposed separately from the battery core.

The cup 14 is in a form of a sealed bag made by means of stamping die, stamping on laminated aluminum films. The cup 14 has a receiving space 140 used for receiving the battery core 11, the two electrode plates 12 and the electrolyte bag 13.

The two electrode plates 12 include a positive electrode plate 121 and a negative electrode plate 122 which are installed in the receiving space 140 of the cup 14. The one end of the positive electrode plate 121 is welded with the positive electrode of the battery core 11. The one end of the negative electrode plate 122 is welded with the negative electrode of the battery core 11. In addition, the other ends of the two electrode plates 12 are welded with the battery core 11 respectively extruded outside of the cup 14.

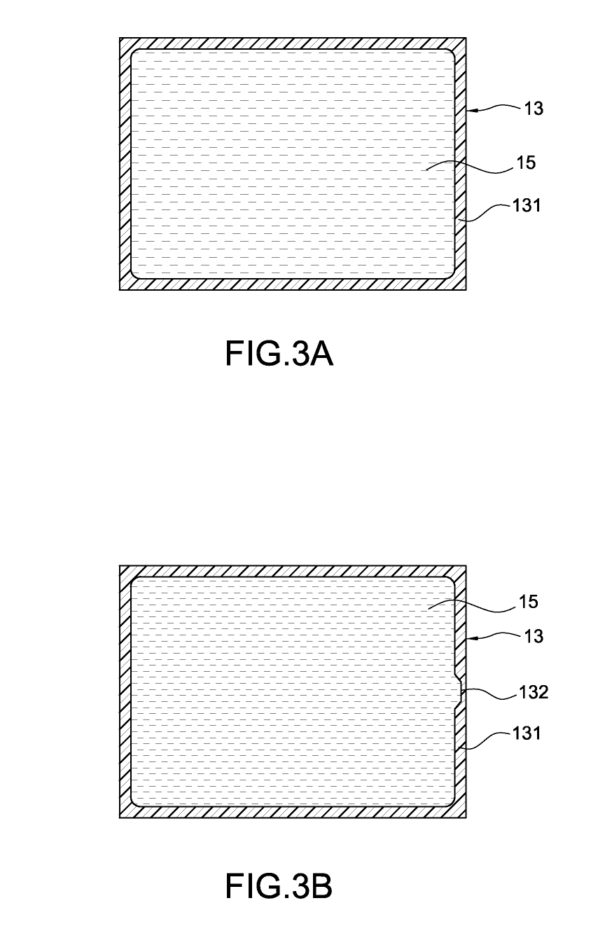

FIG. 3A is a schematic diagram of the electrolyte bag of a preferred embodiment according to the present invention. As shown in the diagram, the electrolyte bag 13 is a sealed bag composed of a plurality of sealed edges 131. When the lithium battery 1 is made, the electrolyte 15 required by the lithium battery 1 is provided in the electrolyte bag 13. When the electrolyte bag 13 is pressured by special tools or manufacturing processes generating cracking on one of the sealed edges 131, the electrolyte 15 is released from the cracking of the electrolyte bag 13.

In the embodiment, the electrolyte 15 accommodated in the electrolyte bag 13 is not in contact with the battery core 11. Therefore, the lithium battery 1 is not charged and is a semi-finished lithium battery. The advantage of the present invention is that, the battery core 11 or the electrolyte 15 of the semi-finished lithium battery (that is, the lithium battery 1 having the electrolyte bag 13) does not deteriorate after keeping in storage for a long time. In addition, the semi-finished lithium batteries are safe and suited to keep in a warehouse or to ship because they are not charged.

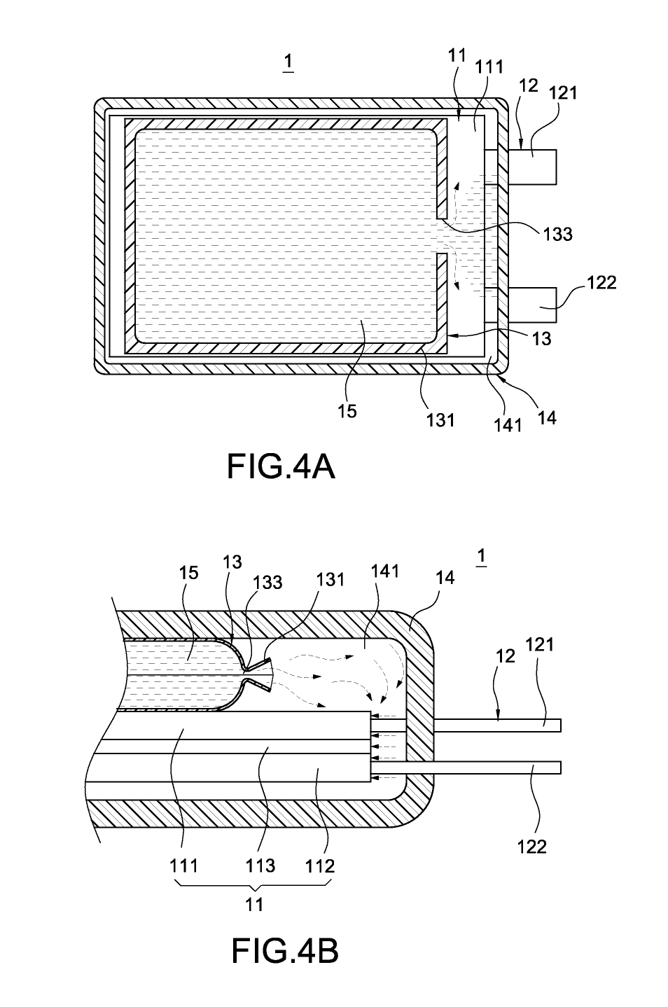

FIG. 3B is a schematic diagram of the electrolyte bag of the other preferred embodiment according to the present invention. One of the sealed edges 131 of the electrolyte bag 13 has at least a thin portion 132. When the electrolyte bag 13 is pressured by special tools or special manufacturing process, the electrolyte bag 13 is cracked on the thin portion 132 to generate a gap 133 (the gap 133 shown in FIG. 4A). Thus, the electrolyte 15 is released from the gap 133 and flows into the receiving space 140 to infiltrate the battery core 11.

FIG. 4A and FIG. 4B are schematic diagrams of the electrolyte release of the first and the second preferred embodiments according to the present invention. When the electrolyte bag 13 is pressured by the special tools or the special manufacturing process and generate the gap 133, the electrolyte 15 in the electrolyte bag 13 is released from the gap 133, and flows into the receiving space 140. In the embodiment, electrolyte 15 is released and flows into the receiving space 140 to infiltrate the battery core 11. The battery core 11 is infiltrated with the electrolyte 15, which accomplished identical results of the manufacturing process for the lithium battery 1 by injecting the electrolyte 15 into the receiving space 140.

As mentioned above, when the battery core 11 is completely infiltrated with the electrolyte 15, the battery core 11 is saturated. The lithium battery 1 undergoes following procedures of charging, activation tests, voltages test, customization and categorization, where the semi-finished lithium battery (that is, the lithium battery 1 having the electrolyte bag 13) is made into a finished lithium battery.

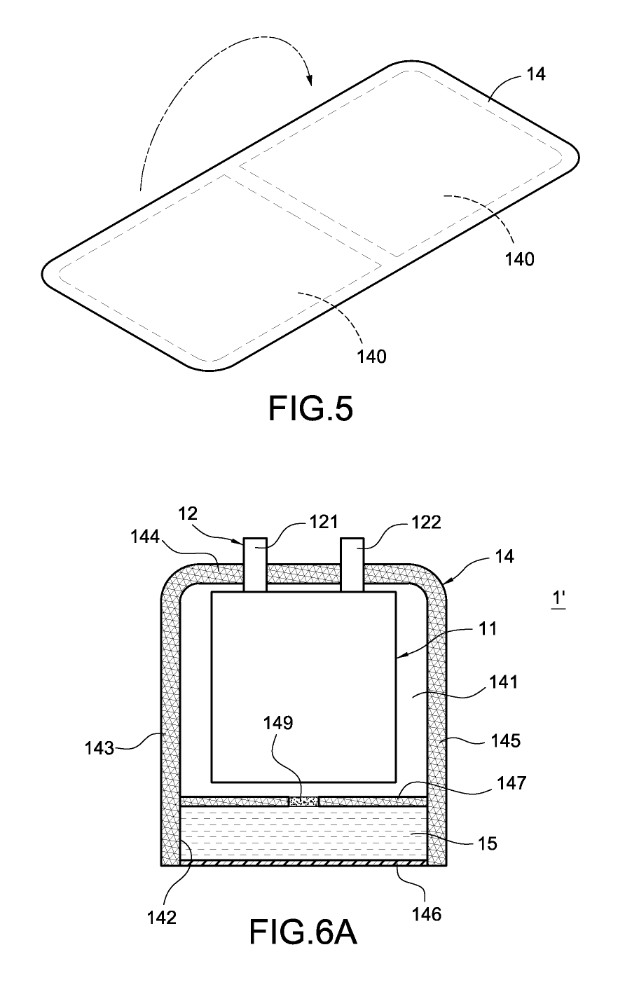

FIG. 5 is an expanded diagram of the cup of a preferred embodiment according to the present invention. As shown in the diagram, the cup 14 can be made of limited aluminum materials. The expanded cup 14 has two receiving sections 140. The two receiving sections 140 are located in corresponding locations. The distance between the two receiving sections 140 is about 10 mm and is not limited thereto.

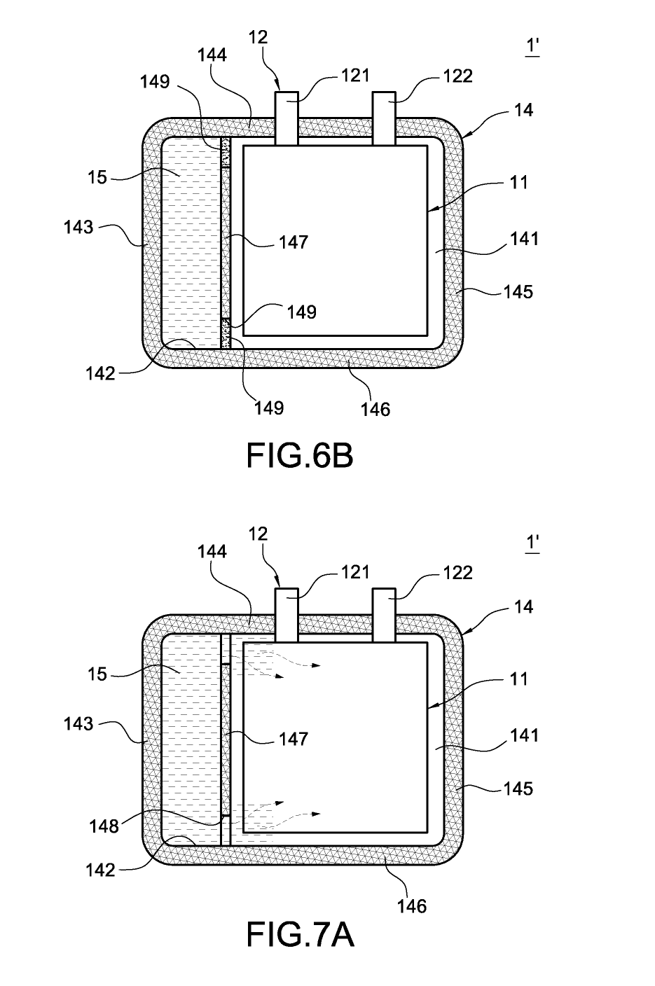

FIG. 6A is a structural sectional diagram of another preferred embodiment according to the present invention. When the cup 14 is folded, the three sealed edges 143, 144 and 145 in addition to the folding edge 146 by hot pressing or with adhesives. The two receiving sections 140 form a sealed space. In the embodiments shown in the above two diagram, the sealed space is the receiving space 140.

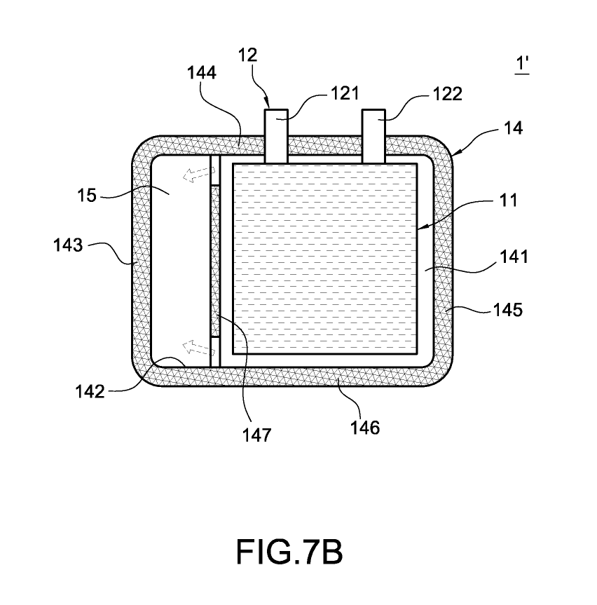

In the structure of the lithium battery 1′ according to the embodiment, the portion near the folding edge 146 on the sealed space is hot pressed to form at least one pressing section 147 and divide the sealed space the receiving space 141 and an electrolyte space 142. Further, a pressing gap 148 (the pressing gap 148 as shown in FIG. 7A) is reserved between the receiving space 141 and the electrolyte space 142, to serves as the communicating path between the receiving space 141 and the electrolyte space 142. A separator 149 can be installed on the pressing gap 148, for example composed of Polyethylene (PE) with low melting point for separating the electrolyte space 142 and the receiving space 141.

In the present embodiment, the battery core 11 is installed in the receiving space 141 and the electrolyte 15 is accommodated in the electrolyte space 142. The electrolyte 15 and the battery core 11 are disposed separately via at least one pressing section 147 and the separator 149. Thus, the lithium battery 1′ of the present embodiment is allowed to accomplished the same purposes as the lithium battery 1 without using the electrolyte bag 13.

FIG. 6B is a structural sectional diagram of the other a preferred embodiment according to the present invention. In the example demonstrated in FIG. 6A, the electrolyte space 142 is configured below the receiving space 141 in the lithium battery 1′. In the example demonstrated in FIG. 6B, the electrolyte space 142 can be configured in the lateral sides of the receiving space 141 the lithium battery 1′ depending on the location of the two receiving section 140 and the pressing section 147 of the cup 14, and should not be limited thereto. In FIG. 6A, the separator 149 is installed in the middle of at least one pressing section 147 (that is, the pressing gap 148 is located on the middle of at least one pressing section 147). As shown in FIG. 6B, the separator 149 can also be installed in two ends of at least one pressing section 147 (that is, the pressing gap 148 located on two ends of at least one pressing section 147). In the embodiment shown in FIG. 6B, the pressing section 147 is not connected with any sealed edges 143, 144, 145 of the cup 14.

It should noted that a degassing procedure is performed on the receiving space 141 for creating a vacuum in the receiving space 141 so as to keep the battery core 11 in dry status in the manufacturing process of the lithium battery 1′ applied on the semi-finished batteries.

FIG. 7A and FIG. 7B are schematic diagrams of the electrolyte release of the third and the fourth preferred embodiments according to the present invention. Before using the lithium battery 1′, the semi-finished lithium battery 1′ undergoes simple processing procedures to generate finished lithium battery 1′ by melting the separator 149. When the separator 149 is melted, the electrolyte 15 in the electrolyte space 142 is released from the pressing gap 148.

At the same time, because the receiving space 141 is in a vacuum, the electrolyte 15 is pressured to flow from through the pressing gap 148 into the receiving space 141 to infiltrate the battery core 11.

Lastly, when the battery core 11 is infiltrated with the electrolyte 15 and the battery core 11 is saturated, the lithium battery 1 undergoes the following procedures of charging and activation tests, where a finished lithium battery is made from the semi-finished lithium battery (that is, the lithium battery 1′ having the electrolyte space 142).

It should be noted that, as shown in FIG. 7B, after the activation procedure of the lithium battery 1′ is performed which generates gases, these gases are pressured to flow from the receiving space 141 to the electrolyte space 142. The electrolyte space 142 may serve as a gas chamber of the lithium battery 1′. Thus, the degassing manufacturing process in finishing the lithium battery 1′ can be waived in order to reduce the manufacturing time and cost of the lithium battery 1′.

As the skilled person will appreciate, various changes and modifications can be made to the described embodiments. It is intended to include all such variations, modifications and equivalents which fall within the scope of the invention, as defined in the accompanying claims.

What is claimed is:

1. An electrolyte storage structure for a lithium battery, comprising:
a cup in a form of a sealed bag with a receiving space;
a battery core installed in the receiving space;
a positive electrode plate installed in the receiving space, one end of the positive electrode plate being welded with the positive electrode of the battery core, the other end of the positive electrode being extruded outside of the cup;
a negative electrode plate installed in the receiving space, one end of the negative electrode plate being welded with the negative electrode of the battery core, the other end of the positive electrode being extruded outside of the cu; and
electrolyte accommodated in the cup and disposed separately from the battery core in the receiving space.

2. The electrolyte storage structure for a lithium battery of claim 1, wherein the battery core is a stack with positive electrode plates and negative electrode plates arranged in order, and a separating film is provided between a positive electrode plate and a negative electrode plate for preventing the positive electrode plate from contacting the negative electrode plate.

3. The electrolyte storage structure for a lithium battery of claim 1, further including an electrolyte bag installed in the receiving space and the electrolyte is accommodated in the electrolyte bag.

4. The electrolyte storage structure for a lithium battery of claim 3, wherein the electrolyte bag is a sealed bag composed of a plurality of sealed edges, and when the electrolyte bag is pressured generating cracking on one of the sealed edges, the electrolyte is released from the cracking.

5. The electrolyte storage structure for a lithium battery of claim 4, wherein one of the plurality of sealed edges has a thin portion, when the electrolyte bag is pressured, the thin portion of the electrolyte bag is cracked to form a gap, the electrolyte is released and flows into the receiving space via the gap.

6. The electrolyte storage structure for a lithium battery of claim 4, wherein the electrolyte bag is made of corrosion resistant materials.

7. The electrolyte storage structure for a lithium battery of claim 6, wherein the electrolyte bag is made of polypropylene (PP).

8. The electrolyte storage structure for a lithium battery of claim 6, wherein the electrolyte bag is made of polyethylene (PE).

9. The electrolyte storage structure for a lithium battery of claim 1, wherein the cup has at least a pressing section, the cup is divided into the receiving space and an electrolyte space via the pressing section, a pressing gap is reserved between the receiving space and the electrolyte space, and the electrolyte is accommodated in the electrolyte space.

10. The electrolyte storage structure for a lithium battery of claim 9, wherein the electrolyte space is configured below the receiving space.

11. The electrolyte storage structure for a lithium battery of claim 9, wherein the electrolyte space configured on the lateral sides of the receiving space.

12. The electrolyte storage structure for a lithium battery of claim 9, wherein the pressing gap is installed on the middle of the pressing section.

13. The electrolyte storage structure for a lithium battery of claim 9, wherein the pressing gap is installed on two ends of the pressing section.

14. The electrolyte storage structure for a lithium battery of claim 9, wherein a separator is disposed on the pressing gap and the battery core in the receiving space is disposed separately from the electrolyte in the electrolyte space via the pressing section and the separator in the lithium battery.

15. The electrolyte storage structure for a lithium battery of claim 14, wherein the separator is composed of polyethylene (PE).

16. The electrolyte storage structure for a lithium battery of claim 14, wherein the receiving space is in a vacuum, and when the separator is processed to melt, the electrolyte in the electrolyte space is released the electrolyte is pressured to flow through the pressing gap into the receiving space.
